(19) United States
(12) Patent Application Publication
(10) Pub. No.: US 2010/0162938 A1
(43) Pub. Date: Jul. 1, 2010

(54) Rescue Boat

(76) Inventor: Leon Halfon, Los Angeles, CA (US)

Correspondence Address: AVERILL & GREEN, 8244 PAINTER AVE., WHITTIER, CA, 90602, US

(21) Appl. No.: 12/646,935

(22) Filed: Dec. 23, 2009

Related U.S. Application Data
(60) Provisional application No. 61/141,222, filed on Dec. 29, 2008.
(60) Provisional application No. 61/168,147, filed on Apr. 9, 2009.

(51) Int. Cl. B63B 35/73; B63B 3/38; B63C 9/02; B32B 3/08

(52) U.S. Cl. 114/343; 156/78

(57) ABSTRACT

A multi-purpose boat has a two angle V hull with a rounded fore-aft profile and slightly convex deck. The hull has steeply angled edge portions and shallowly angled center portions. The edge portions are sufficiently sloped away from vertical to allow the boat to be lifted and not pushed by waves. The rounded fore-aft profile allows the boat to slide over waves, especially during a beach entry. The boat includes a keel having a horizontal base and separating downward from the hull at the fore and aft of the boat to resist yawing. The dry weight of the boat is about 25 pounds with a foam core with a resin coating and the keel is preferably hollow and includes ports to allow water to enter the keel to add about 25 pounds after entering the water. Approximately four inches of freeboard is provided separating riders from cold water and predators.

The present application claims the priority of U.S. Provisional Patent Application Ser. No. 61/168,147 filed Apr. 9, 2009 and of U.S. Provisional Patent Application Ser. No. 61/141,222 filed Dec. 29, 2008 which applications are incorporated in their entirety herein by reference.

### BACKGROUND OF THE INVENTION

The present invention relates to small boats and in particular to a small multi-function boat suitable for recreational use and water rescue.

Known small boats are constructed with a sitting compartment which may fill with water. Such known small boats also often lack stability in rough water, and in the event of rough swells, may fill and sink, or in very cold water, may fill subjecting passengers to hypothermia. Further, beach rescue often requires passing through waves and may prove to be problematic due to difficulty in handling the small boats and may result in injury. Known small boats are also heavy and not easily carried or deployed (e.g., thrown from the deck of a larger ship into the water) by a single person.

Other rescue devices are known, such as flat rescue boards. Unfortunately, such rescue boards have limited utility because they have very little freeboard and a victim carried by the board may be subject to both exposure to cold water, and to attack by marine life. Further, such rescue boards do not provide a stable platform for first aid, such as CPR and/or resuscitation. Therefore, known boats are limited when used in rescue operations.

### BRIEF SUMMARY OF THE INVENTION

The present invention addresses the above and other needs by providing a multi-purpose boat which has a two angle V hull with a rounded fore-aft profile and slightly convex deck. The hull has steeply angled edge portions and shallowly angled center portions. The edge portions are sufficiently sloped away from vertical to allow the boat to be lifted and not pushed by waves. The rounded fore-aft profile allows the boat to slide over waves, especially during a beach entry. The boat includes a keel having a horizontal base and separating downward from the hull at the fore and aft of the boat to resist yawing. The dry weight of the boat is about 25 pounds with a foam core with a resin coating and the keel is preferably hollow and includes ports to allow water to enter the keel to add about 25 pounds after entering the water. Approximately four inches of freeboard is provided separating riders from cold water and predators.

In accordance with one aspect of the invention, there is provided a multi-purpose boat having a unique banana shape providing safe stable use in rough water and large swells, and for entering the water from a beach through surf. The boat is able to ride large swells remaining upright, thereby keeping riders safe from cold water and predators until assistance arrives.

In accordance with another aspect of the invention, there is provided a foam filled and thereby unsinkable boat. The boat may be constructed having a foam core inside a layer of fiberglass or similar material with a resin coating. The resulting structure is free of seams thus reducing or eliminating weak points and is designed to withstand crashing waves or rocky coastlines with minimal damage.

In accordance with yet another aspect of the invention, there is provided a boat preferably weighing no more than 25 pounds dry. The boat may be stored on large boats or ships and thrown into the water by a single person if an evacuation becomes necessary. The boat may further be carried by a single person from a storage area along the beach to a water entry point. When the boat is first placed it the water, if the boat is lands upside down, it is easily flipped to being upright because of the light weight.

In accordance with still another aspect of the invention, there is provided a boat having an outside edge and top surface free of sharp protrusion allowing evacuated riders to easily climb onto the boat. The boat has a shallow rounded bottom allowing one side or end the boat to dip into the water to further allow evacuated riders to easily climb onto the boat.

In accordance with another aspect of the invention, there is provided a banana shaped (or rounded convex) hull design which allows the boat to rise when rushed by water, thereby withstanding large swells. Such design allows the boat to sit deeper in the water so that the water resists excessive rolling, providing needed stability.

In accordance with another aspect of the invention, there is provided a grooved deck top. The grooves allow water to spill from the boat, keeping riders dry in rough swells.

In accordance with another aspect of the invention, there is provided a rescue boat having a low, flat design, sitting only one-quarter of its depth above water with no fins or other protrusions. The boat's design makes climbing aboard from the water easy, without risk of injury. As a rescue device, because of the lack of protrusions on the deck, the boat can be easily flipped once thrown in the water by grabbing the keel and pushing down on one edge to leverage the boat to the upright. The boat is further designed so that the weight of an individual standing at the end of the boat will push that end into the water, so that an injured rescue victim can be easily slid on to the boat. The boat's design also allows it be used for rescue in situations where an individual is trapped in broken ice. The boat's design keeps individuals safe from cold water (hypothermia) and predators without the necessity of life jackets until help arrives. The boat is further designed to serve as a stable rescue diving platform and provides a solid foundation for performing CPR. The boat's flat upper surface allows individuals to stand, making it easier to see and be seen by rescuers. The boat is light weight and provides low wind resistant allowing it to be easily transported on top of most cars, for example, to transport for rescue in flood conditions.

In accordance with another aspect of the invention, there is provided a multi-function boat. Multi-functionality is achieved by the boat's design features and accessories which allow it to be rapidly and easily adjusted for multiple uses, including paddling, surfing, working out, diving, motoring, sailing, and fishing. Accessories include attachable seats, sail, mast, tiller, motor mount, utility box and twelve foot long paddle. The boat may be paddled standing up, seated or lying down. Upright paddling provides an aerobic workout, improving balance and coordination. Increased stability provided by the boat's design enables the individual to stay aboard for longer periods in order to achieve greater enjoyment and superior health benefits. The boat is designed so that it can be used in oceans, lakes, rivers, ponds, and public beaches. The boat is light weight and has low wind resistance allowing easy transportation on top of most cars to a recreational location.

In accordance with another aspect of the invention, there is provided a method for manufacturing a rescue boat to obtain strength and light weight. The method includes step of: covering the interiors of a mold top section and a mold bottom section with contact cement; laying fiberglass in the mold sections over the contact cement; applying resin to the fiberglass in keel portions of the mold interiors; laying a barrier over the keel portion to make a hollow keel; adding fiberglass over barrier; inserting plastic tubing sections into the mold top section to mold rope passages into the interior of the rescue boat; placing the mold top section onto the mold bottom section; pouring foam into mold; letting the foam expand, harden, and penetrate into the fiberglass; separating the mold sections; applying a coat of a flexible resin to the exposed fiberglass of the rescue boat. The barrier over the keel portion is preferably convex or half round to increase the empty volume of the keel. The keel is formed with at least one port, and preferably two vertically spaced apart ports to allow water to enter and exit the hollow keel. Using the method, the boat is constructed from only about two pounds of fiberglass, four pounds of resin, and 19 pounds of foam, providing about 15 pounds of weight savings over known methods which use much more resin. Further, the foam impregnated fiberglass is much more resistant to impacts which often crack brittle resin impregnated fiberglass.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is a side view of a multi-function boat according to the present invention.

FIG. 1B is a top view of the multi-function boat according to the present invention.

FIG. 1C is a front view of the multi-function boat according to the present invention.

FIG. 2A shows how one person can balance using the paddle to get a full body work-out.

FIG. 2B shows use of the boat as a platform for three people for exercise and coordination.

FIG. 3A is a side view of a paddle suitable for use with the multi-function boat.

FIG. 3B is a top view of the paddle suitable for use with the multi-function boat.

FIG. 4 shows the multi-function boat with utility box attached and being paddled by a single seated rider.

FIG. 5 shows the versatility of the multi-function boat with chairs and rowing holders for two riders.

FIG. 6 shows the multi-function boat in use with paddles and chairs for two riders.

FIG. 7 shows two riders paddling the multi-function boat by hand.

FIG. 8 shows use of the multi-function boat to administer CPR in an emergency situation.

FIG. 9 shows one rider paddling the multi-function boat by hand.

FIG. 10 shows a top view of the multi-function boat including recesses for attaching accessories.

FIG. 11 shows a cross-sectional view of the middle of the boat taken along line 11-11 of FIG. 10 showing.

FIG. 12 shows detail 12 of FIG. 11.

FIG. 12A shows details 12 of FIG. 11 with a large accessory attached to the boat.

FIG. 12B shows details 12 of FIG. 11 with a fishing pole attached to the boat.

FIG. 13 shows a perspective top view of the boat with a rider placing a utility box on the boat.

FIG. 14 shows a top perspective view of the boat with wheels attached for easy transporting.

FIG. 15 shows attachment of wheels using bungee cords and inserts inserted into accessory recesses in the boat.

FIG. 16 shows boat strapped to the top of a car.

FIG. 17 shows an accessory strap attached to the boat.

FIG. 18 shows motor mount and motor fitted to the boat.

FIG. 19 shows a chair and motor mount fitted to the boat.

FIG. 20 shows side view of motor mount, motor, chair and utility box inserted onto the boat.

FIG. 21A shows a top view of an installed pontoon accessory which gives the boat stability.

FIG. 21B shows a side view of the installed pontoon accessory which gives the boat stability.

FIG. 21C shows a cross-sectional view of the installed pontoon accessory which gives the boat stability.

FIG. 22A shows a top view of the boat rigged for sailing.

FIG. 22B shows a side view of the boat rigged for sailing.

FIG. 22C shows a cross-sectional view of the boat rigged for sailing.

FIG. 23 shows a cross-sectional view of the boat rigged for sailing.

FIG. 24 shows a goose neck connected to and working in conjunction with a mast and a boom.

FIG. 25 shows a top view of rudder and rope cleat.

FIG. 26 shows the improved cleat with rounded edges which greatly facilitates cleating and releasing the rope.

FIG. 27 shows a bottom view of cleat.

FIG. 28 shows an end view of the cleat.

FIG. 29 shows cross-sectional side view of cleat taken along line 29-29 of FIG. 30.

FIG. 30 shows a top view of the cleat.

FIG. 31 shows a top perspective view of the cleat at a 45 degree angle.

FIG. 32 shows a side view of a second embodiment of the boat comprising a rescue boat according to the present invention with a looping boarding rope around the edge of the deck.

FIG. 33 shows a top view of the rescue boat according to the present invention.

FIG. 34 shows a front (or rear) view of the rescue boat according to the present invention.

FIG. 35 shows a top perspective view of the rescue boat according to the present invention.

FIG. 36 shows a side view of the rescue boat according to the present invention having bow and stern boarding ropes.

FIG. 37 shows a top view of the rescue boat according to the present invention having bow and stern boarding ropes.

FIG. 38 shows a front (or rear) view of the rescue boat according to the present invention.

FIG. 39 shows a cross-sectional view of the second embodiment of the rescue boat according to the present invention taken along line 98-98 of FIG. 96.

FIG. 40 shows a side view of a third embodiment of the boat comprising a second rescue boat having the boarding rope moved inboard.

FIG. 41 shows a top view of the second rescue boat.

FIG. 42 shows a bow or stern view of the second rescue boat.

FIG. 43 shows a top perspective view of the second rescue boat.

FIG. 44 shows a cross-sectional view of the second rescue boat taken along line 44-44 of FIG. 41.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

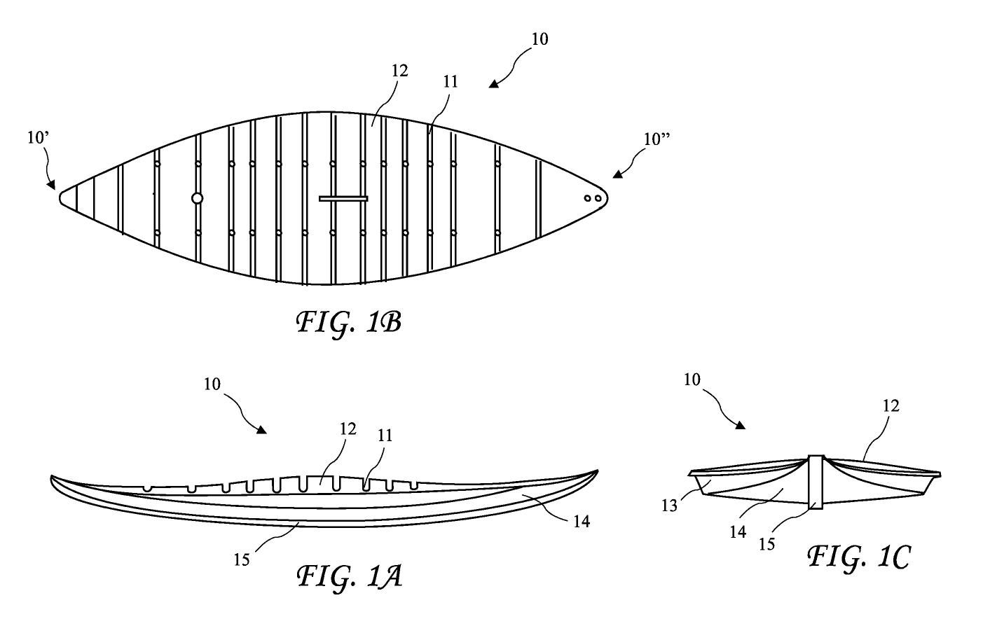

A side view of a multi-function boat 10 according to the present invention is shown in FIG. 1A, a top view of the multi-function boat 10 is shown in FIG. 1B, and a front view of the multi-function boat 10 is shown in FIG. 1C. The boat 10 has a bow 10′, a stern 10″, a unique banana shaped hull 14, a keel 15, and a flat or slightly convex deck 12. The shape of the hull 14 of the boat 10 provides stability in rough water and large swells. The boat 10 preferably weighs no more than about 25 pounds dry and can be stored on large boats or ships and used if an evacuation becomes necessary, and may, for example, be constructed primarily of foam for light weight or from a hollow foam core with a resin coating. Such light weight boat 10 is thereby virtually unsinkable and can withstand crashing waves or rocky coastlines with minimal damage.

The boat 10 has no fins or sharp objects projecting from the deck 12 which might cause injury and as a result, riders can easily climb onto the deck 12. The shape of the hull 14 allows the boat 10 to ride large swells, thereby keeping riders safe from cold water and predators until assistance arrives. When the boat 10 tilts to one side, the rider 20 can simply shift his weight to the other side to level the boat 10 to keep the boat right. The deck 12 further preferably includes grooves 11 making the boat 10 more rigid and allowing water to channel off of the boat 10 quickly, keeping the deck 12 of the boat 10 dry to provide greater stability for a rider 20.

The multifunction boat 10 provides a stable, safe floating platform. The boat 10 is preferably approximately twelve inches thick in the center, with approximately eight inches submerged in the water and approximately four inches freeboard above the water. Due to light weight construction, the boat 10 is able to carry up to 500 pounds for a variety of uses. The boat 10 is preferably approximately twelve feet long, approximately four feet wide and the keel 15 is preferably approximately two inches wide and approximately two inches below the hull 14 at the center of the boat 10. The keel 15 provides stability and tends to keep the boat 10 running straight. The sides 13 of the hull 14 are preferably between 25 and 40 degrees from vertical. When water rushes toward one of the sides 13, the side 13 is lifted (just as when the wind lifts a kite), and the water also pushes against the side 13 of the boat 10 which makes the opposite side 13 of the boat 10 rise up as well, so that the entire boat 10 rises at once. The unique banana shape of the boat 10 and is twelve inches high in the center (including two inches of keel height), and one inch in the bow and the stern, making the boat 10 capable of handling large swells, waves and storms.

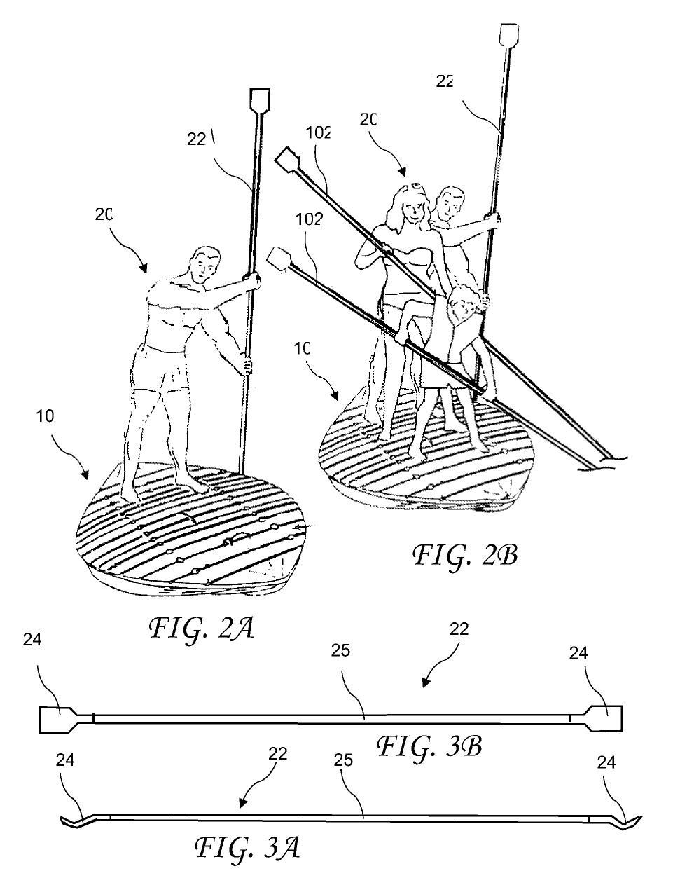

A rider 20 paddling with a two handed paddle 22 is shown in FIG. 2 while standing on deck 14 of the boat 10. This is very different from any other water craft currently on the market. The rider 20 is shown putting the paddle 22 in the water. This enables him to stabilize himself, gaining balance from the surf, because the paddle 22 is approximately 12 feet long, depending on the height of the rider 20. Standing provides the rider 20 with a better view. Similarly to a high wire performer, when the rider 20 paddles in a standing position, he is exercising his balance with the movement of the water. As the rider 20 paddles, he raises his arm on one side and then the other. This movement, executed while standing, enables the rider 20 to exercise his lungs at maximum capacity. With the movement of the boat, he is also exercising his legs. While paddling, he is twisting to the right and the left and dropping downward and stretching upward, thereby getting a total body work out. While standing with a 12 ft paddle 22, the rider 20 is able to reach farther and execute longer strokes.

A more detailed side view of the two handed paddle 22 is shown in FIG. 3A, and a more detailed top view of the two handed paddle 22 is shown in FIG. 3B. The paddle 22 is preferably made of a tubular fiberglass or graphite handle 25, to give sufficient strength and balance. Two spoons 24 at ends of the handle 25 are preferably approximately 10 to 12 inches long by approximately 6 inches wide, and are preferably smaller in comparison to other paddles to allow for long fast movements in paddling.

Three riders 20 are shown in FIG. 2B on the boat 10. The three riders 20 are able to paddle together, making this sport a group or family exercise.

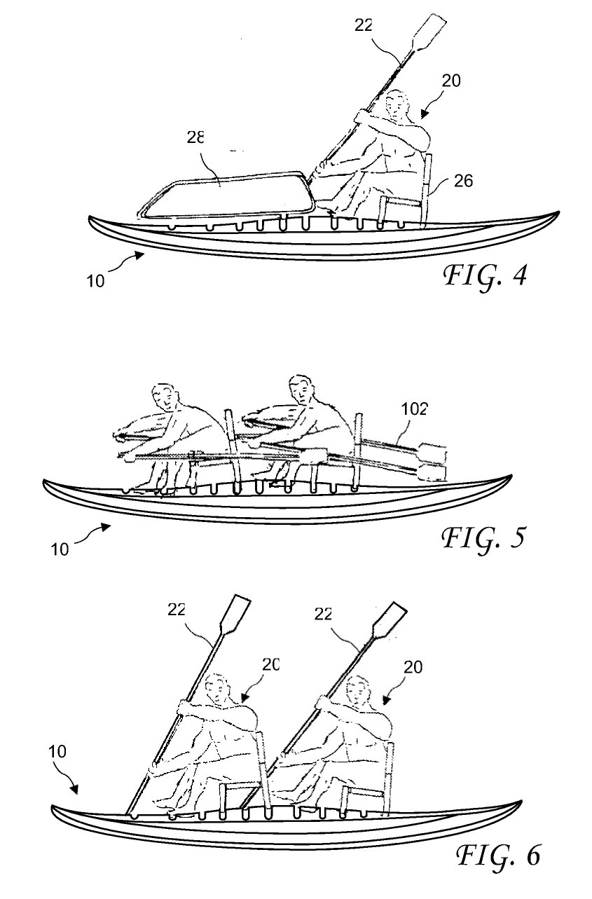

The rider 20 is shown sitting on a chair 26 on the multifunction boat 10 in FIG. 4 with a utility box 28 attached providing additional uses of the boat 10, for example, for fishing and diving. The utility box 28 provides storage and fishing rods 112 can be installed in the recesses 14 (see FIG. 10). The rider 20 may further paddle the boat 10 from a seated position like a kayak. Unlike a kayak, however, the rider 20 is above the water and not as susceptible to being drenched by cold waves. The hull 14 design further provides stability to allow the rider 20 to stand up and use the utility box 28.

The versatility of the boat 10 is further illustrated in FIG. 5 showing the boat 10 used for rowing as a platform with two chairs 26 and two riders 20 are shown sitting on the chairs and paddling in FIG. 6. The riders 20 are also able to stand and paddle or sit on the chair 26 when he becomes tired. The rider 20 is further able to create his own customized attachments that best suit his needs.

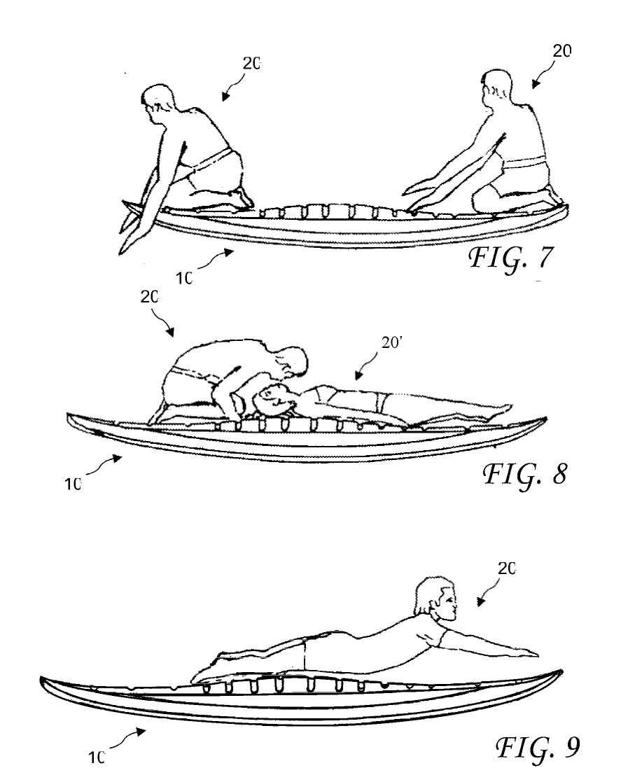

Two riders 20 are shown kneeling on the boat 10 and paddling by hand in FIG. 7, the boat 10 is shown as a platform for administering CPR or emergency help to a drowning victim 20′ in FIG. 8, and one rider 20 is shown lying on his stomach on the boat 10 and paddling by hand in FIG. 9. The rider 20 is able to hand one end of the twelve foot long paddle 22 to the drowning victim and bring him toward the boat 10. Further, the rounded shape of the hull 14 of the boat 10 allows the rider 20 to walk forward and sink the bow or the stern of the boat 10 making it easier to slide a victim from the water onto the boat 10. Similarly, objects may be retrieved from the water using the paddle 22. Due to the features described above, this invention is particularly useful for ocean, lake, flood, and ice rescue.

A top view of the boat 10 showing accessory recesses 16 is shown in FIG. 10. The deck of the boat 10 has grooves 11 for allowing water to run off the deck easier, and recesses 16 may be aligned with the grooves 11 for accessory inserts 16.

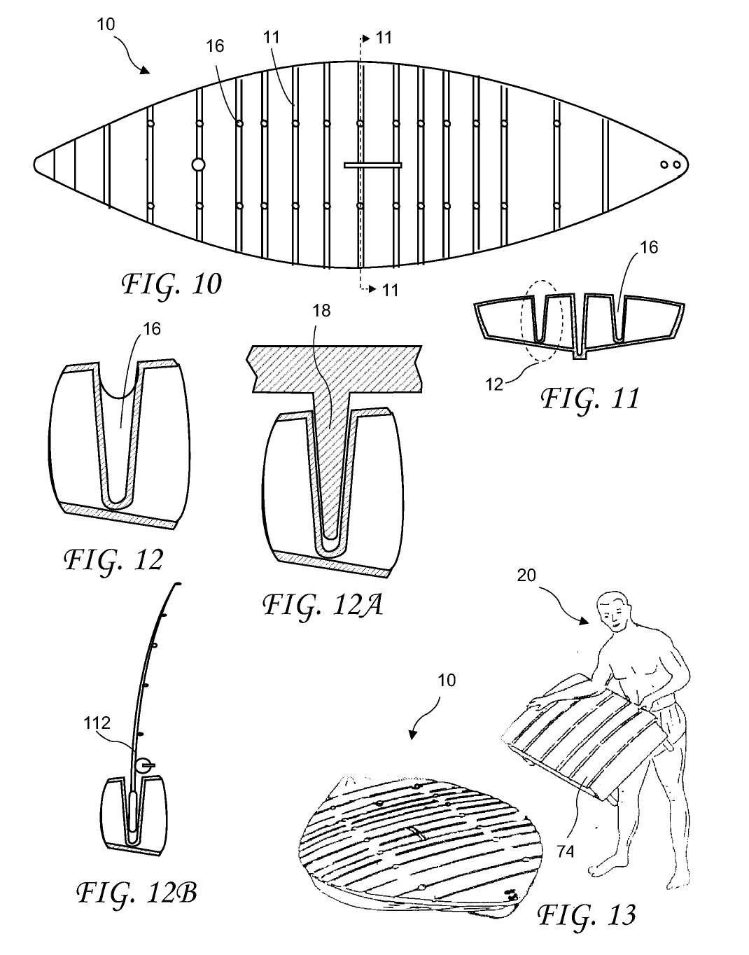

A cross-sectional view of the boat 10 taken along line 11-11 of FIG. 10 is shown in FIG. 11, showing details of the recesses 16.

The detail 12 of FIG. 11 of the recess 16 is shown in FIG. 12 and the detail 12 of FIG. 11 showing an accessory inserts 18 inside the recess 16 is shown in FIG. 12A and with a fishing pole 112 inserted into the recess 16 in FIG. 12B. The recesses 16 may thus be used to attach a variety of accessories having inserts 18 or, like a fishing pole 112, having a handle or other feature, insertable into the recess 16.

A top perspective view of the boat 10 and a rider 20 preparing to install an accessory 74 onto the boat 10 is shown in FIG. 13.

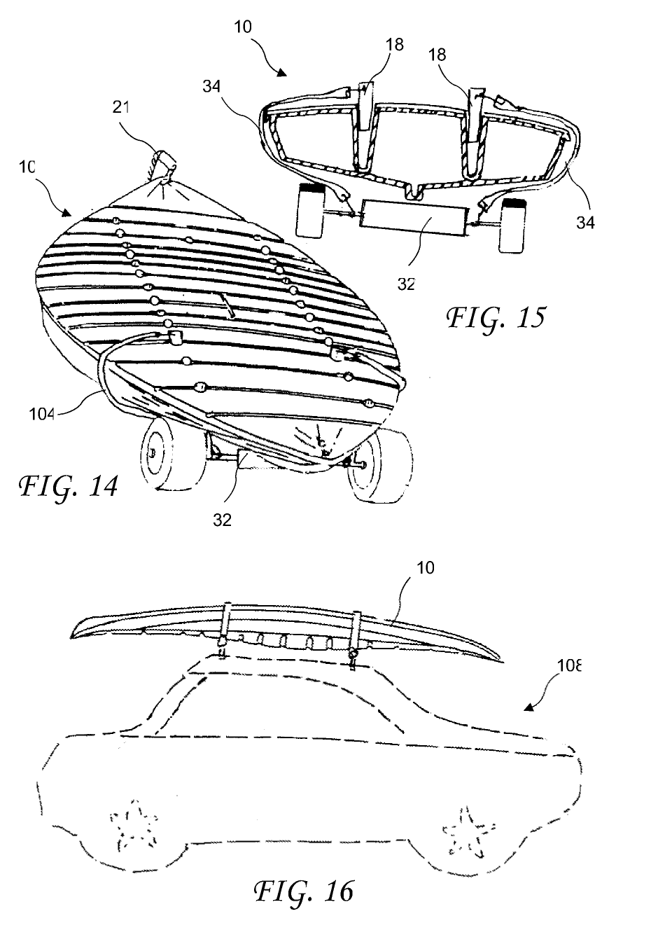

A top perspective view of the boat 10 with wheels 32 attached for easy transporting is shown in FIG. 14 and attachment of wheels 32 using bungee cords 34 stretched on top of the boat 10 and inserts 18 inserted into accessory recesses 16 in the boat 10 is shown in FIG. 15. Using the accessory recesses 16 to attached the wheels 106 resists fore or aft slipping and provides a secure attachment of the wheels 32. A handle 20 on the boat 10 is then used to move the boat 10 to or from the water. Once the wheels 32 are pulled off of the boat 10, the boat is smooth and free of any external object that may cause injury.

The boat 10 is shown strapped to the top of a car 108 in FIG. 16 for easy long distance transporting. The aerodynamic shape of the boat 10 facilitates such transporting on the top of a vehicle.

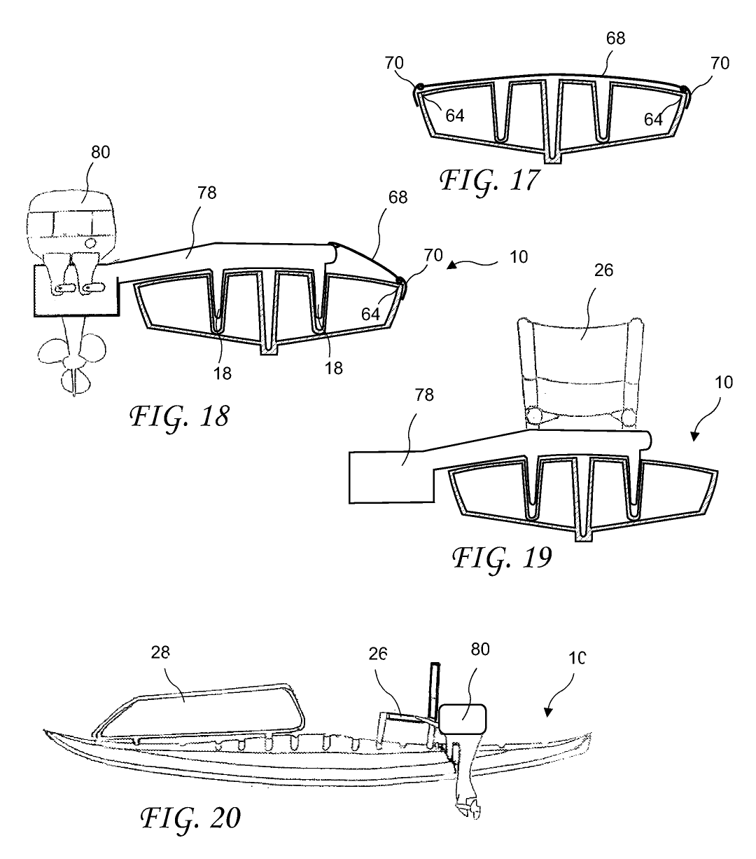

A side view of the boat 10 is shown in FIG. 17 showing an accessory strap (e.g., a rope, strap, or bungee) 68 attached to the boat 10 and passing over the deck 12. Hooks 70 at each end of the strap 68 hook over lips 64 on edges of the deck 12. The strap 68 may include a Velcro® fastener or a short rope, attached to the strap 68 to hold the paddle 22 to the boat 10. The strap 68 may thus restrain the paddle 22, a utility box, a pontoon, a sailing saddle and other article to the boat 10.

A cross-sectional view of the boat 10 with an outboard motor 80 attached to the boat 10 by a motor mount 78 is shown in FIG. 18, the motor mount 78 is shown fitted on the boat 10 without the motor 80 in FIG. 19, and a side view of the boat 10 with the motor 80 is shown in FIG. 20. The motor mount 78 includes inserts 18 inserted into the recesses 16 and the strap 68 hooked over the lip 64 to buckle firmly to the boat 10.

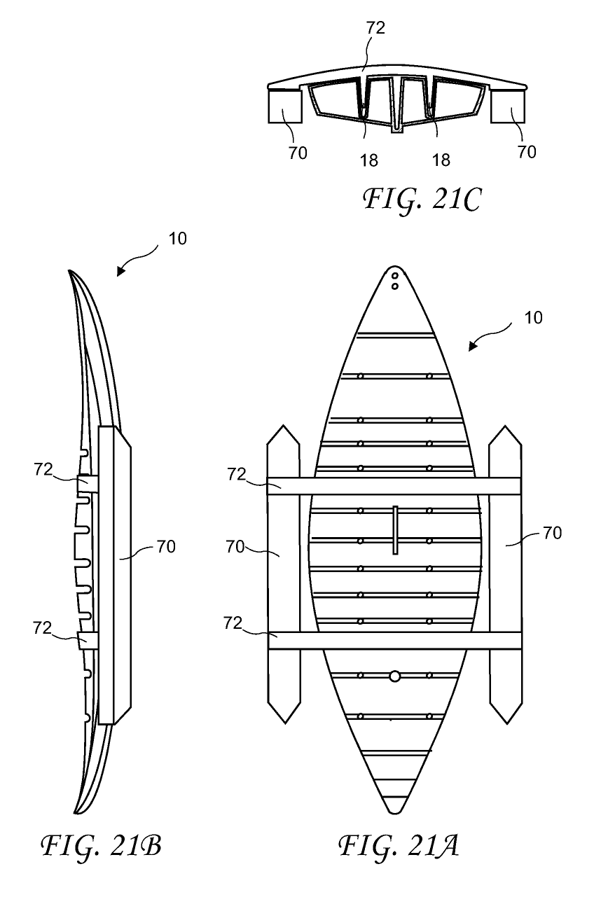

A top view of pontoons 70 fitted on the boat 10 is shown in FIG. 21A, a side view of the pontoon 70 fitted on the boat 10 is shown in FIG. 21B, and a cross-sectional view of the pontoon 70 fitted on the boat 10 is shown in FIG. 21C. Booms 72 reach across the deck 12 and are held in position by inserts 18 inserted into the recesses 16 in the deck 12. Straps 68 connected to the lip 64 shown in FIG. 17 are preferably used to further hold the boom 72 in place. The pontoons 70 provides more stability and the booms 72 may be laterally extendable if desired for greater stability.

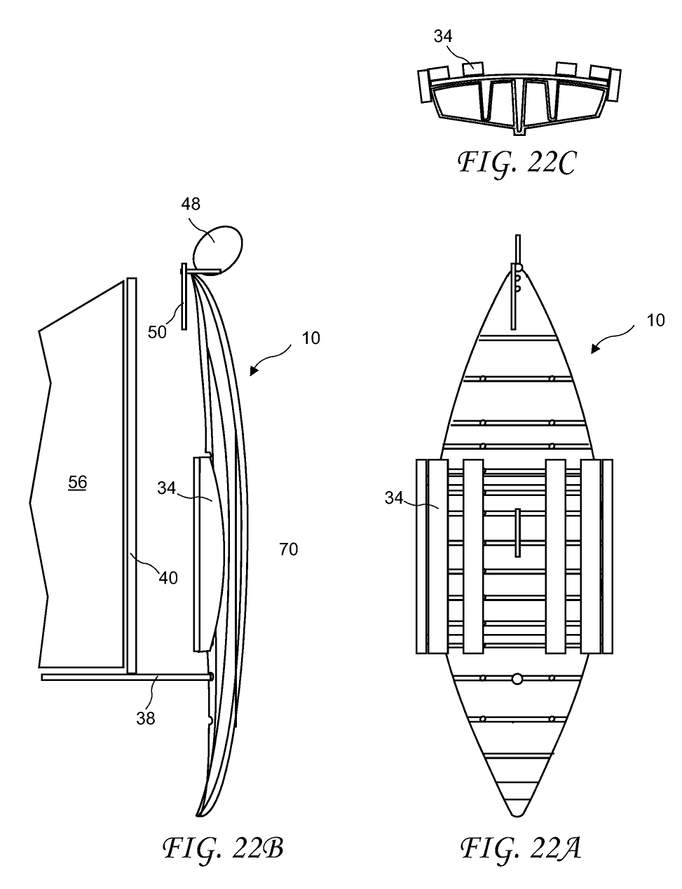

A top view of the boat 10 rigged for sailing is shown in FIG. 22A, a side view of the boat 10 rigged for sailing is shown in FIG. 22B, and a cross-sectional view of the boat 10 rigged for sailing is shown in FIG. 22C. The boat 10 is shown rigged for sailing and includes a mast 38, boom 40, sail 56, rudder 48, and tiller 50. The boat 10 rigged for sailing further includes a sailing saddle 34 used for leverage while sailing demonstrating how the sailing saddle 34 resides on the deck 12 and includes inserts 18 inserted into the recesses 16 for holding the position of the saddle 34 on the deck 12, and further may include straps having hooks engaging the lip 64 to stay secure on the deck 12. The mast 38 is shown fitted into the boat 10 into one of the recesses 16 and the rudder 48 and tiller 50 may be fitted on the boat 10, for example, with two plastic bolts and wing nuts. The rudder 48 is preferably hinges to lift when it touches the ground. The mast and rudder are removable from the boat 10, leaving no fins or hooks or any sharp projections which may cause injury.

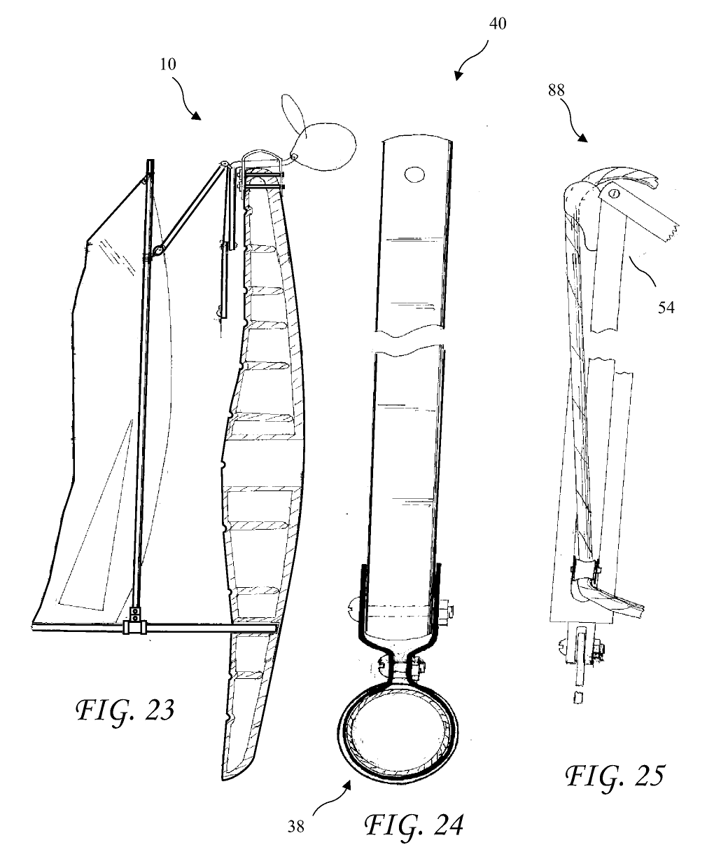

A side view of the boat 10 rigged for sailing is shown in FIG. 23 and a detailed top view of the boom 40 is shown in FIG. 24.

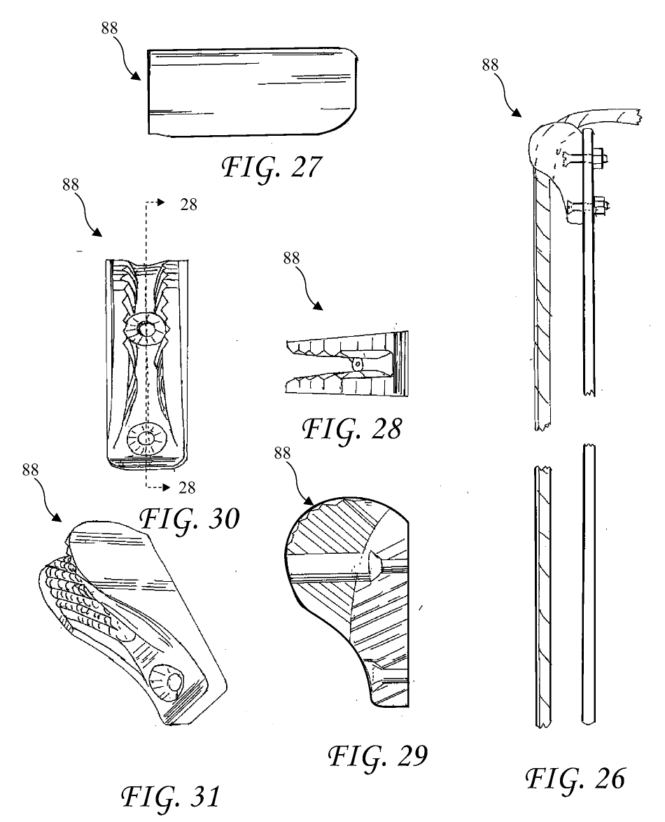

A cleat 88 according to the present invention at the end of a rudder handle 54 is shown in FIGS. 25-31. The round shape of the cleat 88 is unique, making it easier to cleat a rope. All that is needed is to bend the rope around the cleat and it will pull it in firmly. With other cleats, the operator has to push in the ropes to cleat. When sailing, an individual has only two arms to maneuver and this invention makes it faster and easier for corners.

The boat 10 may be constructed of foam with a plastic coating. The boat preferably weighs approximately 25 pounds, and may be thrown off a larger boat or dock for rescue. A drowning person can easily climb onto the boat and stay safe from cold water and predators on a stable platform. Even a dog is able to climb on the boat. The boat may thus be modified for many purposes.

A preferred embodiment of the multifunction boat 10 is a rescue boat 10a. The rescue boat 10a weighs approximately 25 pounds dry and is preferably approximately 8 feet in length. The rescue boat 10a is preferably constructed as one solid piece with no seams thus having no weak points. In addition, the rescue boat 10a is preferably constructed from a hollow foam core with an epoxy coating. The rescue boat 10a is designed so that it can withstand crashing waves or rocky coastlines with minimal damage. Because of its light weight, the rescue boat 10a may be stored on large boats or ships and used if an evacuation becomes necessary, and can be thrown into the water by one person. Evacuated passengers can easily climb onto the rescue boat 10a which has no fins or sharp objects which can cause injury. The rescue boat 10a is able to ride large swells, thereby keeping riders safe from cold water and sharks until assistance arrive.

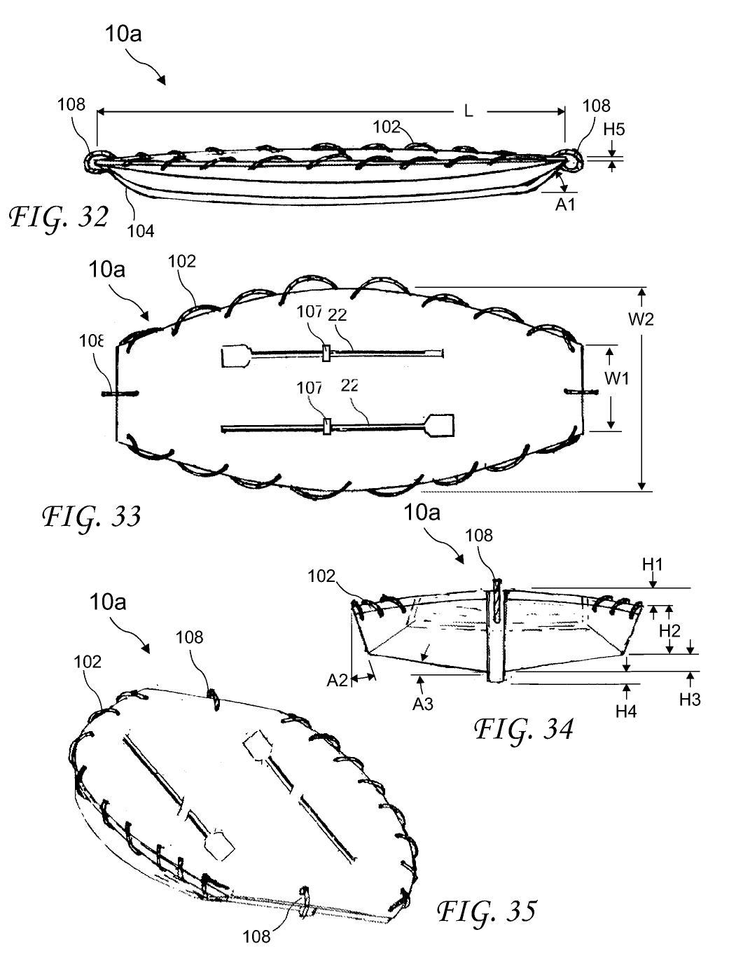

A side view of the rescue boat 10a according to the present invention is shown in FIG. 32, a top view of the rescue boat 10a is shown in FIG. 33, a front (or rear) view of the rescue boat 10a is shown in FIG. 34, and a top perspective view of the rescue boat 10a is shown in FIG. 35. The rescue boat 10a includes a looping boarding rope 102 along each side, attached by passing through holes along the edge of the rescue boat 10a. The boarding rope allows a swimmer to grasp and pull themself onto the rescue boat 10a. The rescue boat 10a is sufficiently wide to resist turning over when a swimmer attempts to climb aboard. Additionally, the rescue boat 10a has a rounded hull bottom allowing the rescue boat 10a to roll somewhat, to make climbing aboard easier for a tired swimmer. The cooperation of the width and the rounded hull bottom provide significant benefits in a rescue scenario.

Preferably, the boarding rope 102 is stitched along each side, about 2 inches from the edge of the rescue boat 10a. The boarding rope 102 is inserted through holes on each side of the rescue boat 10a. The holes are lines with a plastic tube which is level with the top and bottom of the holes to prevent foam from pulling or tugging at the boarding rope 102. Handles 108 are provided at the bow and stern of the rescue boat 10a for carrying or otherwise moving the rescue boat 10a. The handles 108 are preferably attached through holes through the rescue boat 10a about 4 inches in from the bow and stern similar to the attachment of the boarding rope 102. Oars (or paddles) 106 reside in oar recesses 116 (see FIG. 39) and are held in place by straps 107, which are preferably Velcro® material. The oars 106 are thus easily extracted for use in an emergency. The oars are preferably about 6 feet long and can be used like a canoe paddle or two ores may be connected together to form a twelve foot paddle.

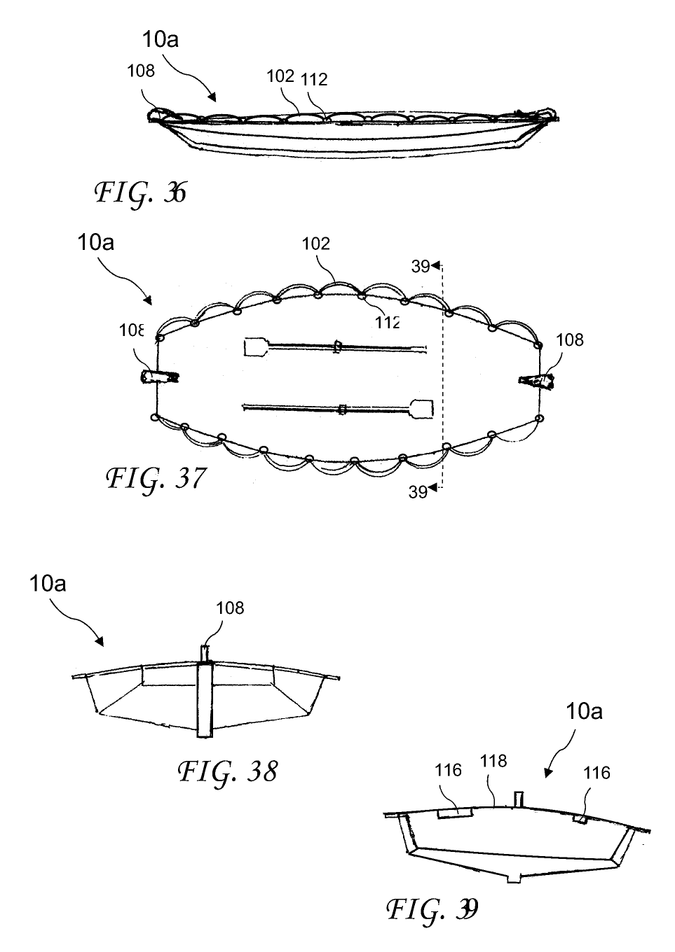

A side view of the rescue boat 10a showing bow and stern boarding ropes 108 and the boarding rope 102 attached by hardware 112 is shown in FIG. 36, a top view of the rescue boat 10a having the boarding rope 102 attached by hardware 112 is shown in FIG. 37, a front (or rear) view of the rescue boat 10a having the boarding rope 102 attached by hardware 112 is shown in FIG. 38, and a cross-sectional view of the rescue boat 10a showing recesses for oars is shown in FIG. 39. The hardware 112 may be any hardware mounted to the rescue boat 10a to facilitate attaching the boarding rope 102 for example, a toggle bolt inserted into the rescue boat 10a.

The deck 12 of the rescue boat 10a is preferably convex so that any water which passes over the rescue boat 10a water immediately runs off the rescue boat 10a. The rescue boat 10a has a length L, bow and stern widths W1, overall width W2, bow and stern edge tapers A1, side edge tapers A2, hull slope A3, deck height H1, wall height H2, bottom height H3, and keel height H4. The bow and stern ends of the rescue boat 10a are blunt ends with a height H5 to reduce or prevent both injury to a swimmer who might encounter the boat and to reduce or eliminate damage to the boat from hitting hard objects. The dimensions are preferably approximately:

L is between 6 and 10 feet and is preferably about 8 feet;

W1 is between 1 and 3 feet and is preferably about 2 feet;

W2 is between 3 and 6 feet and is preferably about 4.5 feet;

H1 is between ¼ and 2 inches and is preferably about 1 inch;

H2 is between 6 and 10 inches and is preferably about 8 inches;

H3 is between 1 and 3 inches and is preferably about 2 inch;

H4 is between 1 and 3 inches and is preferably about 2 inch;

H5 is between 1 and 2 inches and is preferably about 1 inch;

A1 is between 30 and 50 degree and is preferably about 40 degrees;

A2 is between 25 and 40 degree and is preferably about 30 degrees; and

A3 is between 5 and 15 degree.

Another embodiment of the rescue boat 10b is shown in FIGS. 40-43. The rescue boat 10b is similar to the rescue boat 10a but has a second boarding rope 110 moved inboard to allow easier grasping by an individual in the water, and more secure attachment to the boat 10b. The boarding rope 110 is preferably secured to the rescue boat 10b by running the boarding rope 110 through tubes buried inside the rescue boat 10b. The keel 15 of the rescue boat 10b has an approximately horizontal base 15a for most the length of the keel 15, and separates vertically from the hull 14 at the bow and stern of the boat 10b, providing fin like structures to add stability to the boat 10b. The horizontal base 15a extends for 80 percent of the length of the rescue boat 10b.

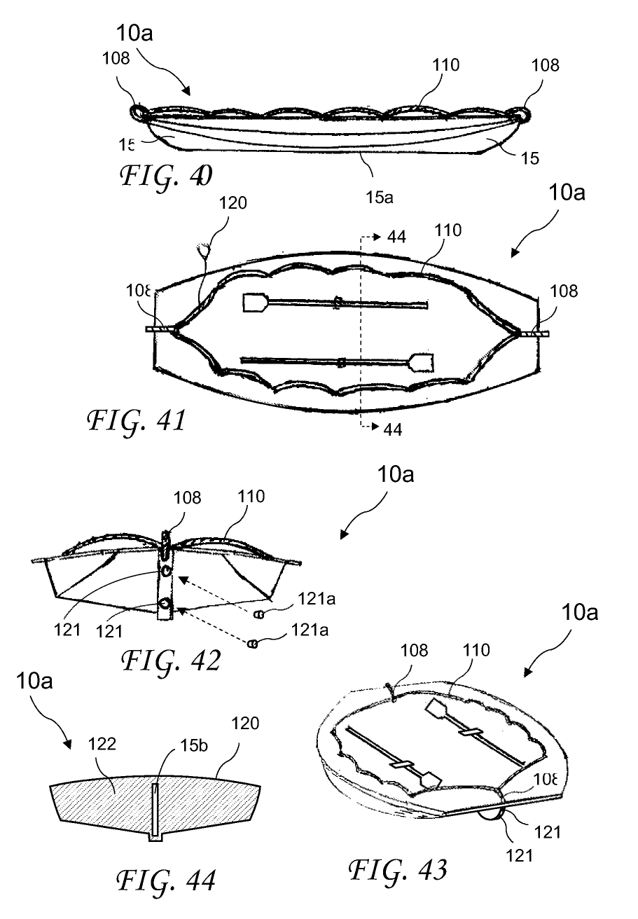

A cross-sectional view of the boat 10b taken along line 44-44 of FIG. 41 is shown in FIG. 44 showing a fiberglass exterior 120, a foam filled interior 122, and a hollow keel 15b. Vertically spaced apart passages 121 allow water to flow into the hollow keel 15a when the boat is in the water for stability, and allow the water to drain from the hollow keel 15a when the boat 10b is removed from the water to provide light weight. Plugs 121a are provided to block the passages 121 to prevent water from entering the hollow keel, to retain water in the hollow keel, or to control the amount of water in the hollow keel. The passages 121 are preferably only at the rear of the boat 10b.

The boat 10b is constructed using a novel method to provide a light weight and rugged boat. The method includes steps of: covering the interiors of a mold top section and a mold bottom section with contact cement; laying fiberglass in the mold sections over the contact cement; applying resin to the fiberglass in keel portions of the mold interiors; laying a barrier over the keel portion to make a hollow keel; adding fiberglass over barrier; inserting plastic tubing sections into the mold top section to mold rope passages into the interior of the rescue boat; placing the mold top section onto the mold bottom section; pouring foam into mold; letting the foam expand, harden, and penetrate into the fiberglass; separating the mold sections; and applying a coat of a flexible resin to the exposed fiberglass of the rescue boat. The barrier over the keel portion is preferably convex or half round to increase the empty volume of the keel. The keel is formed with at least one port, and preferably two vertically spaced apart ports to allow water to enter and exit the hollow keel. The step of covering the mold interiors with contact cement is preferably performed by spaying the contact cement onto the interior surfaces of the molds. The resin applied to the exterior is preferably a colored resin to color the exterior of the boat. While fiberglass is a preferred cloth molding material, the cloth used may also be graphite cloth, carbon fiber cloth, or any other suitable cloth. A boat constructed according to the present invention is very light and strong because the foam partially saturates the fiberglass reducing the amount of resin in the boat.

The foam is preferably a close cell marine foam, referred to as a floatation foam, a two part pour foam, and Coast Guard approved, for example, 1117 foam made by Revchem Plastics in Bloomington, Calif.

While the invention herein disclosed has been described by means of specific embodiments and applications thereof, numerous modifications and variations could be made thereto by those skilled in the art without departing from the scope of the invention set forth in the claims.

I claim:

1. A multi-purpose boat comprising:
a bow;
a stern;
between approximately six and ten foot length;
between approximately three and six foot width at a widest point;
between approximately six and sixteen inches overall height;
a hull comprising;
walls reached downward from the deck and inclined inward and downward at between 25 and 40 degrees from the vertical and tapering shallower at the bow and the stern of the boat;
a bottom below the walls sloping upwards and outwards towards the walls at between 5 and 15 degrees from the horizontal and forming a continuous arc from the bow to the stern of the boat to allow the boat to move through waves and remain righted;
a keel along the bottom; and
a convex deck.

2. The boat of claim 1, wherein the keel is hollow and includes at least one port allowing water to enter the keel.

3. The boat of claim 2, wherein the keel is hollow and includes two vertically spaced apart ports allowing water to enter the keel.

4. The boat of claim 3, wherein the boat weighs not more than approximately 25 pounds when dry and the hollow keel fills with at least 15 pounds of water when the boat is in the water.

5. The boat of claim 3, wherein the boat weighs not more than approximately 25 pounds when dry and the hollow keep fills with approximately 25 pounds of water when the boat is in the water.

6. The boat of claim 1, wherein the keel has an approximately horizontal base and separates vertically from the hull at the bow and stern of the boat providing fin like structures to add stability to the boat

7. The boat of claim 6, wherein the horizontal base of the keel extends for approximately 80 percent of the length of the boat.

8. The boat of claim 1, wherein the boat consists essentially of:
approximately four pounds of resin;
approximately two pounds of fiberglass; and
approximately 19 pounds of foam.

9. The boat of claim 1, wherein the boat is constructed essentially of foam, fiberglass, and resin, and the fiberglass is volumetrically impregnated approximately ⅔ by the foam and approximately ⅓ by the resin to provide a strong and light weight boat.

10. A multi-purpose boat comprising:
a bow;
a stern;
approximately eight foot length;
approximately four and one half feet wide at a widest point;
approximately twelve inches high at the greatest height;
a hull constructed of foam filled fiberglass and a resin coating over the fiberglass, the fiberglass volumetrically impregnated approximately ⅔ by the foam and approximately ⅓ by the resin and weighting about 25 pounds, the hull comprising;
walls inclined inward and downward from the deck at between 25 and 40 degrees from the vertical and tapering shallower at the bow and the stern of the boat;
a bottom below the walls sloping upwards and outwards towards the walls at between 5 and 15 degrees from the horizontal and forming a continuous arc from the bow to the stern of the boat to allow the boat to move through waves and remain righted;
a hollow keel along the bottom;
two vertically spaced apart passages into the hollow keel allowing water to enter and the leave the hollow keel; and
a convex deck.

11. A method for constructing a rescue boat, the method comprising:
covering the interiors of a mold top section and a mold bottom section with contact cement;
laying cloth molding material in the mold sections over the contact cement;
applying resin to the fiberglass in keel portions of the mold interiors;
laying a barrier over the keel portion to make a hollow keel; adding fiberglass over barrier;
placing the mold top section onto the mold bottom section;
pouring foam into mold; letting the foam harden;
separating the mold sections; and
applying a coat of a flexible resin to the exposed fiberglass of the rescue boat.

12. The method of claim 11, further including inserting plastic tubing sections into the mold top section to mold rope passages into the interior of the rescue boat.

13. The method of claim 11, further including forming at least one passage into the hollow keel for allowing water to enter the keel to add weight to the rescue boat in the water.

14. The method of claim 13, further including forming two vertically spaced apart passages into the hollow keel for allowing water to enter the keel to add weight to the rescue boat in the water.

15. The method of claim 11, wherein covering the interiors of a mold top section and a mold bottom section with contact cement comprises spraying contact cement on the interiors.

15. The method of claim 10, wherein laying cloth molding material in the mold sections over the contact cement comprises laying fiberglass in the mold sections over the contact cement.
